(19) United States
(12) Patent Application Publication
(10) Pub. No.: US 2024/0117849 A1
(43) Pub. Date: Apr. 11, 2024

(54) DISC BRAKE FOR RAILWAY VEHICLES

(71) Applicants: COFREN S.R.L, AVELLINO - AV (IT); POLI S.R.L, CAMISANO - CR (IT)

(72) Inventors: Vittorio De Soccio, Avellino (IT); Roberto Boffelli, Camisano (CR) (IT)

(21) Appl. No.: 18/480,333

(22) Filed: Oct. 3, 2023

(30) Foreign Application Priority Data
Oct. 6, 2022 (IT) 102022000020598

(51) Int. Cl. F16D 65/092; F16D 69/02

(52) U.S. Cl. CPC F16D 65/092; F16D 69/02; F16D 69/027; F16D 55/22

(57) ABSTRACT

A disc brake for railway vehicles comprising a pad and a disc on which the pad acts. The pad comprises a base plate and a plurality of friction elements fixed to the base plate. The friction elements comprise first friction elements made with a first friction material and second friction elements made with a second friction material. The first friction material has a compressibility modulus greater than that of the second friction material by a value greater than or equal to 1 MPa. The first friction elements are in a higher number than the second friction elements. A respective elastic element is interposed between each of the first friction elements and the base plate, whereas a respective rigid spacer is interposed between each of at least part of the second friction elements and the base plate.

### CROSS-REFERENCE TO RELATED APPLICATIONS

This patent application claims priority from Italian patent application no. 102022000020598 filed on Oct. 6, 2022, the entire disclosure of which is incorporated herein by reference.

### BACKGROUND

### Technical Field

The present invention relates to a disc brake for railway vehicles. In particular, the present invention is advantageously, but not exclusively, applied to medium/low speed railway vehicles.

Here and in the following, medium/low speed trains mean trains whose maximum speed is equal to 220 Km/h.

### Discussion Of Art

As is known, disc brakes are subject to high stresses and, to obtain an optimum brake action, it is necessary to have a good transmission of the braking force from the pad to the disc.

For a long time now, brake pads comprising a plurality of friction elements having reduced dimensions have been used, instead of only one friction element having greater dimensions. One of the solutions adopted to this regard provides for each pad to be substantially constituted by a main base plate and by a plurality of friction elements fixed to the base plate. Generally, each of the friction elements is composed of a sheet and of a friction insert fixed in an irreversible manner to the sheet.

The solution relative to the use of a plurality of friction elements having reduced dimensions is advantageous both in terms of effectiveness of the pressure on the disc and, thus, of braking, and in terms of low noise.

To such regard, it should be highlighted that the low noise has increasingly become an important discriminating factor for choosing the disc brakes to use. This is particularly true for the medium/low speed trains programmed for making a high number of stops, such as, for example, underground, regional or intercity trains.

One of the problems that the use of the pads having a plurality of friction elements has had to deal with has concerned the formation of circular depressions on the disc of the brake. The presence of such circular depressions necessarily results in a damage of the friction elements of the pad.

This problem has been solved by increasing the friction surface of at least part of the friction elements. In particular, the friction elements are arranged in arched rows which, in use, are superimposed on respective concentric lines of the disc on which the pad acts and, substantially, the friction elements of the outermost rows have greater dimensions than the friction elements of the innermost rows. Furthermore, for this solution to be effective, the friction elements of each row have to act on a portion of surface of the disc which is partially superimposed on the portions of the surface of the disc on which friction elements of an outermost row and of an innermost row act.

It has been experimentally demonstrated that the above-described solution, despite being effective towards the problem of the grooves created on the disc, entails a loss in terms of static friction between the pad and the disc.

Furthermore, the friction elements can be coupled on the base plate in elastic condition or in rigid condition. The difference between these two coupling conditions depends on whether an elastic element, for example a Belleville washer, is interposed between the friction element and the base plate. It has been experimentally noted that should the friction elements be coupled in elastic condition, the static friction between pad and disc is worsened.

The need was thus felt to have a type of disc brake, whose technical characteristics are such to guarantee the required levels of static friction even if the pads are constituted by a plurality of friction elements.

The inventors of the present invention have provided a solution relative to a pad for disc brakes capable of satisfying the above-mentioned need, by intervening on a differentiated elasticity of the elastic elements depending on their different compressibility.

### BRIEF DESCRIPTION

One object of the present invention is a disc brake for railway vehicles comprising a pad and a disc on which the pad acts. The pad includes a base plate and a plurality of friction elements fixed to the base plate. The friction elements comprise first friction elements made with a first friction material and second friction elements made with a second friction material. The first friction material has a compressibility modulus (pressure necessary to compress the material by 1 mm) greater than that of the second friction material by a value greater than or equal to 1 MPa, preferably 2 MPa. The first friction elements are in a higher number than the second friction elements. The pad for disc brakes for railway vehicles can have an elastic element interposed between each of the first friction elements and the base plate, and by the fact that a respective rigid spacer is interposed between each of at least part of the second friction elements and the base plate.

Here and in the following, an elastic element means an element that has the deformation of 1 mm by applying a value less than or equal to 1 MPa, whereas rigid spacer means a spacer made with a material with deformation of 1 mm by applying a force greater than or equal to 2 MPa.

A respective rigid spacer can be interposed between each of the second friction elements and the base plate.

The friction elements can be arranged in rows of arcuate shape and in use substantially superimposed on respective concentric lines of the disc on which the pad acts. Each row of the arcuate shapes can include both the first friction elements and the second friction elements.

In each of the arched rows, the first friction elements can be equal to or greater in number than the second friction elements.

The first material can have a compressibility modulus of between 2 and 40 MPa, and the second material can have a compressibility modulus of between 1 and 20 MPa.

The first friction material can be a sintered material and the second friction material can be an organic material.

The sintered material can have a composition composed of: from 10 to 70% by weight of copper, from 5 to 50% by weight of iron, from 5 to 30% by weight of graphite, from 1 to 15% by weight of friction modifiers.

The organic material can have a composition composed of: from 5 to 30% by weight of rubber and resin, from 10 to 50% by weight of filler, from 5 to 20% by weight of graphite, from 5 to 20% by weight of friction modifiers.

The disc brake object of the present invention can be applied to low/medium speed trains.

### BRIEF DESCRIPTION OF THE DRAWINGS

To better understand the invention, an embodiment is described in the following by way of mere non-limiting example with the aid of the figures of the accompanying drawing, wherein:

FIG. 1 is a top view, with parts in transparency for clarity, of a pad object of the present invention;

FIG. 2 is a section along line II-II of FIG. 1;

FIG. 3 is a section along line III-III of FIG. 1;

FIG. 4 is a graph in which the friction coefficient values of a disc brake of comparison are registered; and

FIG. 5 is a graph in which the friction coefficient values of the brake of the disc of FIG. 1 are registered.

### DETAILED DESCRIPTION

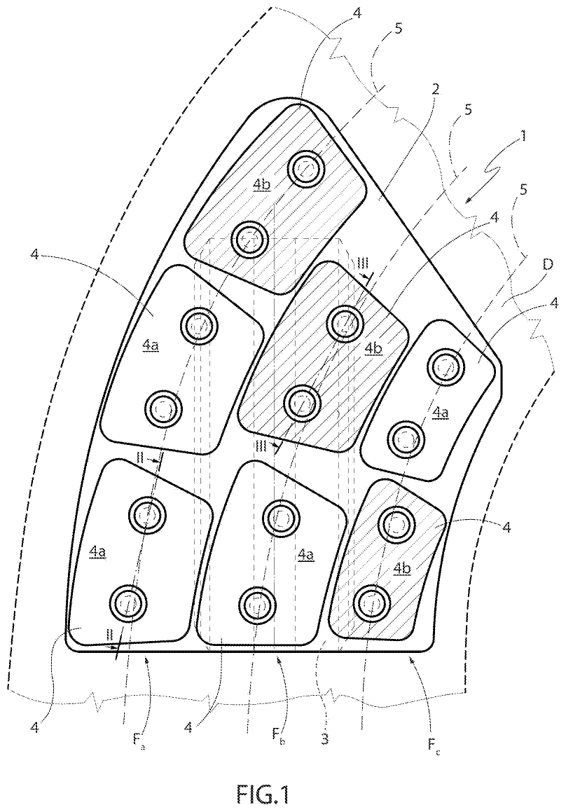

In FIG. 1, reference numeral 1 indicates, as a whole, a pad for disc brakes according to the present invention.

The pad 1 comprises a base plate 2, a “dovetail” fixing element 3, which is fixed on a rear surface of the base plate 2 and designed for fixing the pad 1 to a structure of the disc brake, and a plurality of friction elements 4 fixed to the base plate 2 and arranged for exerting the pressure on the disc of the brake for producing the braking action.

For the purposes of the present invention, it is irrelevant if the friction elements 4 can be fixed to the plate 2 in a reversible manner or in an irreversible manner.

The friction elements 4 are arranged along arched rows illustrated by a dashed line and indicated by 5, which in use are substantially superimposed on concentric lines of a disc D on which the pad 1 acts. For simplicity, the disc D is illustrated by a dashed line and only partially.

The friction elements 4 are divided into four friction elements 4a made of sintered friction material and three friction elements 4b made of organic friction material. For clarity, the friction elements made of organic material 4b are represented by a dashed surface.

The organic material of the friction elements 4b has a composition which satisfies the following conditions: from 5 to 30% by weight of rubber and resin, from 10 to 50% by weight of filler, from 5 to 20% by weight of graphite, from 5 to 20% by weight of friction modifiers.

The organic material has a compressibility modulus of 7 MPa.

The sintered material of the friction elements 4a has a composition which satisfies the following conditions: from 10 to 70% by weight of copper, from 5 to 40% by weight of iron, from 5 to 20% by weight of graphite, from 1 to 10% by weight of friction modifiers.

The sintered material has a compressibility modulus of 27 MPa.

Unlike what described above, the first material and the second material can both be sintered materials or both organic materials, if the conditions of compressibility modulus mentioned in the claims are respected.

The materials of different compressibility can be obtained, besides by materials with different chemical nature, also by means of a different preparation process of a same chemical type of material.

For example, by intervening on the porosity of the resulting material, it will be possible to modify the compressibility.

In particular, the friction elements 4 are arranged on three rows identifiable as an outer row Fa, an intermediate row Fb and an inner row Fc.

The outer row Fa comprises three friction elements 4 having equal dimensions, whereas the intermediate row Fb comprises two friction elements 4 having equal dimensions and each of which has a friction surface equal to that of each of the elements of the outer row Fa.

Differently, the inner row Fc comprises two friction elements 4 equal to each other and each of which has a friction surface less than that of each of the elements of the outer row Fa or of the intermediate row Fb.

The friction elements 4 of each row exert their action on a portion of disc D which is superimposed on the portions of disc D on which the friction elements 4 of the subsequently outermost and innermost rows act.

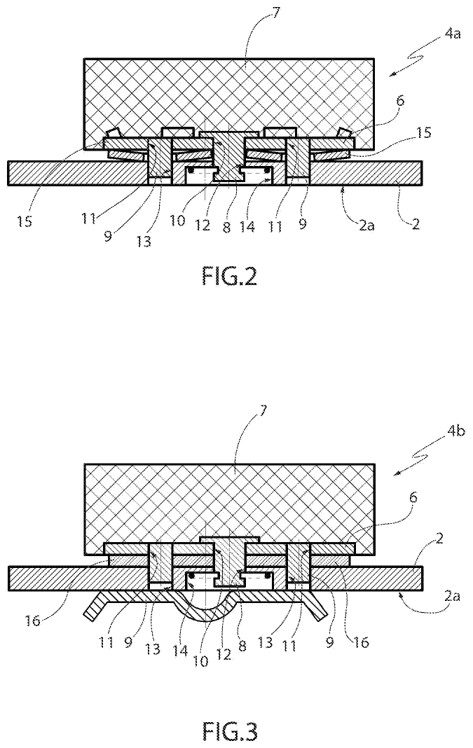

As is illustrated in FIGS. 2 and 3, each of the friction elements 4 is composed of a sheet 6 having a flat shape, of an insert 7 made of friction material and fixed in an irreversible manner to the sheet 6, of a fixing pin 8 and of two anti-rotation plugs 9.

In the sheet 6, a central hole 10 is obtained engaged by the fixing pin 8 and two side holes 11, each of which is engaged by a respective anti-rotation plug 9.

Once the friction element 4 is assembled, the heads of the fixing pin 8 and of the anti-rotation plugs 9 are embedded in the friction material of the insert 7.

For each of the friction elements 4, on the base plate 2 a central hole 12 and two side holes 13 are obtained. The central hole 12 has a diameter greater than the side holes 13 and is obtained in the center of a respective circular recess 14 obtained, in turn, on a lower surface 2a of the base plate 2. The circular recess 14 houses a locking spring 12 which engages a circumferential groove obtained in the fixing pin 8.

FIGS. 2 and 3 illustrate two different coupling conditions. In particular, the coupling condition illustrated in FIG. 2 provides for the presence of two Belleville washers 15 and, according to the invention, it is applied to the friction elements which provide for the sintered friction material, i.e. the material which has a greater compressibility modulus.

Each of the two Belleville washers 15 is arranged between the sheet 6 and the base plate 2, and has a hole engaged by a respective anti-rotation plug 9.

Differently, the coupling condition illustrated in FIG. 3 provides for the presence of two rigid spacers 16 and, according to the invention, it is applied to the friction elements which provide for the organic friction material, i.e. the material which has a lesser compressibility modulus.

Each of the two rigid spacers 16 is arranged between the sheet 6 and the base plate 2, and has a hole engaged by a respective anti-rotation plug 9. In particular, the two rigid spacers 16 are made of any material capable of withstanding the specific pressures and the heat generated during the braking, such as metals or plastic materials, in one single piece or composed of the sum of lesser thicknesses.

Essentially, according to the invention, in the pad the friction elements made with a low-compressibility friction material are coupled to the base plate in an elastic condition, whereas at least part of the friction elements made with a high-compressibility friction material are coupled to the base plate in a rigid condition.

The inventors of the present invention carried out experimental tests, in order to verify the advantages in terms of static friction coefficient given by the present invention.

Such experimental tests were carried out by means of a dynamometric test bench in compliance with the UIC 541-3 standard.

For the sake of clarity, the dynamometric test bench used is a BIO-PW4 Type model produced by the company SCHENCK PEGASUS GmbH, Darmstadt.

The tests were carried out using a brake of comparison and a brake according to the present invention.

The brake of comparison is distinguished from the brake of the present invention exclusively because, in the relative pad, all the friction elements 4a and 4b are coupled to the plate with the presence of the Belleville washers. Differently, the brake according to the present invention, as is illustrated in FIGS. 1-3, provides in the relative pad for the friction elements 4a (sintered friction material—lesser compressibility) to be coupled to the base plate by means of the interposition of the Belleville washers (elastic coupling condition), whereas the friction elements 4b (organic friction material—greater compressibility) to be coupled to the base plate by means of the interposition of the rigid spacers (rigid coupling condition).

In other words, in the pad of the brake of comparison all the friction elements, regardless of the compressibility of their friction material, are coupled to the base plate by means of the interposition of the Belleville washers; differently, in the pad of the brake according to the invention, only the friction elements with friction material having lesser compressibility are coupled to the base plate by means of the interposition of the Belleville washers, whereas the friction elements with friction material having greater compressibility are coupled to the base plate by means of the interposition of the rigid spacers.

The disc brake of comparison and the disc brake according to the invention were subjected to the experimental tests according to the above-mentioned conditions and following a procedure for verifying the static friction not referred to a particular project.

In particular, the experimental procedure used provides, once the pads are compressed on the disc with a force between 10 and 50 kN, for the dynamometric test bench to start increasing the torsional moment on the disc until the same starts rotating and, therefore, the pads start sliding with respect to the disc. The torsional moment on the disc continues increasing until reaching the speed of 0.8 km/h of the disc. Such speed is maintained for a period of 5 seconds.

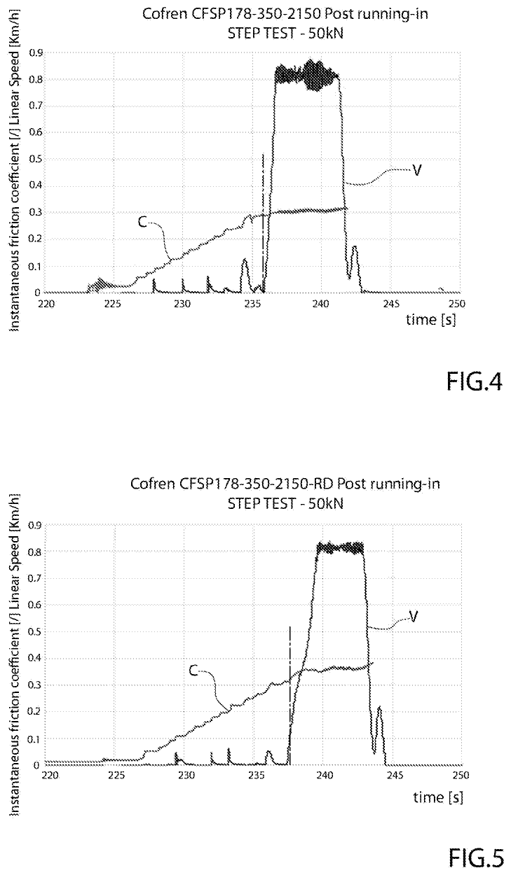

The graphs of FIGS. 4 and 5 show the friction coefficients registered depending on the speeds of the disc and of the application time of the torsional moment for the force of 50 kN, which is the most representative in the railways field of the latest generation vehicles.

For convenience, the ordinate shows on one single scale both the friction coefficient values and the speed values of the disc.

In the graphs of FIGS. 4 and 5 the curve relative to the friction coefficient is indicated by C, whereas the curve relative to the speed of the disc is indicated by V.

As can be obvious for a person skilled in the art, the static friction coefficient is detected on the graphs at the beginning of the rotation of the disc. In graphs 4 and 5 a dash-dot line was inserted for identifying the static friction values detected as described above.

As it is possible to verify from the graphs of FIG. 4 and of FIG. 5, with the brake according to the invention a sensibly greater static friction coefficient is registered than that registered with the brake of comparison.

In fact, in the graph of FIG. 4 a static friction coefficient value less than 0.3 is registered; whereas in the graph of FIG. 5 a static friction coefficient value greater than 0.30 is registered, in the order of 0.35.

Such a difference is exclusively due to the different coupling conditions of the friction elements, this being the sole condition that changes between the brake of comparison and that of the invention.

Based on the above description, it is evident that the present invention allows guaranteeing the required levels of static friction coefficient for a pad having a plurality of friction elements, while maintaining all the advantages deriving from the presence of the plurality of friction elements.

The core of the invention lies in the different elasticity conferred to the friction elements depending on their compressibility.

1. A disc brake, comprising:
a pad including a base plate and first and second friction elements fixed to the base plate, the first friction elements made with a first friction material and the second friction elements made with a second friction material, the first friction material having a compressibility modulus greater than the compressibility modulus of the second friction material by at least one megapascal, the pad including more of the first friction elements than the second friction elements, wherein a respective elastic element is interposed between each of the first friction elements and the base plate, and wherein a respective rigid spacer is interposed between each of at least part of the second friction elements and the base plate.

2. The disc brake of claim 1, wherein the compressibility modulus of the first friction material is greater than the compressibility modulus of the second friction material by at least two megapascals.

3. The disc brake of claim 1, wherein the respective rigid spacer is interposed between each of the second friction elements and the base plate.

4. The disc brake of claim 1, wherein the elastic element includes a Belleville washer.

5. The disc brake of claim 1, further comprising a disc on which the pad acts, wherein the first and second friction elements are arranged in arcuate rows substantially superimposed on respective concentric lines of the disc, each of the arcuate rows comprising both the first friction elements and the second friction elements.

6. The disc brake of claim 5, wherein each of the arcuate rows includes at least as many of the first friction elements as the second friction elements.

7. The disc brake of claim 1, wherein the compressibility modulus of the first friction material is between twenty and forty megapascals, and the compressibility modulus of the second friction material is between one and twenty megapascals.

8. The disc brake of claim 1, wherein the first friction material is a sintered material and the second friction material is an organic material.

9. The disc brake of claim 1, wherein the pad is configured for braking low or medium speed trains.

10. A disc brake, comprising:
a base plate;
first friction elements fixed to the base plate and including a first friction material;
second friction elements fixed to the base plate and including a second friction material that is different from the first friction material, the first friction material having a greater compressibility modulus than the second friction material;
an elastic element between each of the first friction elements and the base plate; and
a rigid spacer between each of the second friction elements and the base plate.

11. The disc brake of claim 10, wherein the disc brake includes more of the first friction elements than the second friction elements.

12. The disc brake of claim 10, wherein the compressibility modulus of the first friction elements is at least one megapascal greater than the compressibility modulus of the second friction elements.

13. The disc brake of claim 10, wherein the compressibility modulus of the first friction elements is at least two megapascals greater than the compressibility modulus of the second friction elements.

14. The disc brake of claim 10, wherein the elastic element between each of the first friction elements and the base plate includes a washer.

15. The disc brake of claim 10, wherein the first friction material includes a sintered material.

16. The disc brake of claim 15, wherein the second friction material includes an organic material.

17. A railway disc brake, comprising:
a base plate;
a first number of first friction elements fixed to the base plate and including a sintered friction material; and
a second number of second friction elements fixed to the base plate and including an organic friction material, the sintered friction material having a compressibility modulus that is at least two megapascals greater than the organic friction material, the first number of the first friction elements being greater than the second number of the second friction elements.

18. The disc brake of claim 17, further comprising:
an elastic element between each of the first friction elements and the base plate.

19. The disc brake of claim 18, wherein the elastic element between each of the first friction elements and the base plate includes a washer.

20. The disc brake of claim 17, further comprising:
a rigid spacer between each of the second friction elements and the base plate.
